(19) United States
(12) Patent Application Publication
(10) Pub. No.: US 2016/0134389 A1
(43) Pub. Date: May 12, 2016

(54) OPTICAL TRANSMITTER AND METHOD TO CONTROL THE SAME

(71) Applicant: SUMITOMO ELECTRIC INDUSTRIES, LTD., Osaka (JP)

(72) Inventor: Tetsu MURAYAMA, Yokohama-shi (JP)

(21) Appl. No.: 14/937,503

(22) Filed: Nov. 10, 2015

(30) Foreign Application Priority Data
Nov. 12, 2014 (JP) 2014-230040

(51) Int. Cl. H04J 14/02; H04B 10/564; H04B 10/079

(52) U.S. Cl. CPC H04J 14/0221; H04B 10/07955; H04B 10/564

(57) ABSTRACT

An optical transmitter that outputs a wavelength multiplexed signal that multiplexing sub-signals generated by respective LDs. The bias current and the modulation current supplied to the LD are determined such that the sub-signal transmitting the optical multiplexer shows optical power independent of the temperature, and adjusted such that the extinction ratio and the average power of the sub-signal transmitting the optical multiplexer satisfy the preset condition by sensing the sub-signal in upstream of the optical multiplexer.

### BACKGROUND OF THE INVENTION

1. Field of the Invention

The present application relates to an optical transmitter including an arrayed waveguide (AWG) for multiplexing optical signals and a method to control the optical transmitter.

2. Background Arts

An optical communication system constituting a core network and communication between data servers in a data center often implement with optical transceiver in physical layers of the open systems interconnection (OSI) reference model to transmit and receive optical signals and to covert signals between an electrical form and an optical from. An optical transmitter in the optical transceiver converts an electrical signal into an optical signal and transmits thus converted optical signal into an optical fiber. Two methods have been well known to convert an electrical signal to an optical signal using a semiconductor laser diode (LD) as an optical source; that is, the direct modulation and the external modulation. In the former modulation, a modulated optical signal may be obtained by varying a current flowing in an LD in a pulsed form by a driver.

An optical transmitter usually implements with an auto-power control (APC) to keep optical power of an optical signal, which is output from an LD to an optical waveguide, in constant. A Japanese patent with a laid open No. JP-H07-240555A has disclosed an optical transmitter that senses a portion of an optical signal output from an LD by a photodiode (PD) and controls a driving current supplied to the LD based on sensed optical signal to maintain the optical power output from the LD in a preset level.

As extreme increase of communication traffic in the network causes a continuous demand for an optical transceiver to be formed in compact and to save power thereof in order to realize a huge traffic capacity by downsized apparatuses and densely distributed communication channels. For instance, one of multisource agreements (MSAs) is defined for an optical transceiver applicable to 100 Gbps communication as the CFPMSA (100 G Form-factor Pluggable Multi-Source Agreement). Also other MSAs calls as the CFP2 and/or CFP4 derived from the CFPMSA are defined for further compact optical transceivers. In the CFPMSA, two optical signals each multiplexing four sub-signals are concurrently transmitted and received to realize the full-duplex communication. Setting a symbol rate of respective sub-signals to be 25 to 32 Gbaud, the CFP may perform the communication with 100 to 128 Gbps transmission rate. Another MSA called QSFP+ (Quad Small Form-factor Pluggable+) defines that four sub-signals each having 10 Gbps rate are multiplexed to realize total 40 Gbps transmission rate.

Such optical transceivers implement with an optical multiplexer type of a 3 dB coupler and/or an arrayed waveguide (AWG) to multiplex the sub-signals. However, an AWG inherently shows wavelength dependence in the transmittance thereof. When an optical signal in a wavelength thereof shifts from a designed wavelength, the AWG shows substantial insertion loss, or increases the insertion loss. Also, an LD shows large temperature dependence in an emission wavelength thereof. Accordingly, the optical power of one of sub-signals, which is emitted from an LD and multiplexed by the AWG, widely varies as the temperature of the LD varies depending on the insertion loss of the AWG.

On the other hand, the APC for the one of the sub-signals to be multiplexed by the AWG monitors the sub-signal before entering the AWG. In such a case, the optical power of the monitored sub-signal is almost constant even when the wavelength thereof shifts depending on the temperature of the LD. Thus, an optical transmitter implementing with an optical multiplexer whose transmittance or insertion loss, like an AWG, depends on the wavelength of the optical signal transmitted therethrough, the optical power of the sub-signal varies as the temperature varies even when the monitored power of the sub-signal sensed before the optical multiplexer is not varied. Accordingly, the APC for the sub-signal is obstructed.

### SUMMARY OF THE INVENTION

One aspect of the present application relates to a method of controlling an optical transmitter that is implemented with a laser diode (LD) and an optical multiplexer. The LD generates a sub-signal having a temperature dependent wavelength. The optical multiplexer multiplexes the sub-signal and has wavelength dependent insertion loss for an optical signal transmitting therethrough. The method of an embodiment comprises steps of: (1) sensing an operating temperature of the LD; (2) deciding a condition of the LD at the operating temperature such that the sub-signal transmitting through the optical multiplexer has optical power substantially independent of the operating temperature; and (3) setting the condition in the LD.

Another aspect of the present application relates to an arrangement of an optical transmitter. The optical transmitter of one embodiment of the present application comprises an optical source, an optical multiplexer, a driver, a temperature sensor and a controller. The optical includes at least two laser diodes (LDs) each generating sub-signals having wavelengths different from each other. The optical multiplexer multiplexes the sub-signals each generated by the LDs and generates a wavelength multiplexed signal. The optical multiplexer has a wavelength dependent insertion loss for an optical signal transmitting therethrough. The driver supplies driving currents to the at least two LDs independently. The temperature sensor senses a temperature of an inside of the optical transmitter. The controller maintains optical power of the sub signals transmitting through the optical multiplexer in a preset power independent of the temperature by setting the driving currents to the at least two LDs based on optical power of the sub-signals in upstream of the optical multiplexer.

### BRIEF DESCRIPTION OF DRAWINGS

The foregoing and other purposes, aspects and advantages will be better understood from the following detailed description of a preferred embodiment of the invention with reference to the drawings, in which:

FIG. 1 shows a functional block diagram of an optical transmitter according to an embodiment of the preset application;

FIG. 2 schematically explains the insertion loss of an arrayed waveguide (AWG) against the wavelength of an optical signal transmitting therethrough;

FIG. 3 schematically explains wavelength dependence of a difference between optical power of an optical signal measured in upstream of the AWG and that measured in downstream of the AWG;

FIG. 4 schematically compares the I-L (current to optical power) characteristic of an optical signal measured in upstream of the AWG with those measured in downstream of the AWG;

FIG. 5 shows temperature dependence of a bias current and a modulation current supplied to an laser diode (LD) by which an optical power measured in downstream of the AWG becomes independent of the temperature;

FIG. 6 shows a flow chart to control a bias current and a modulation current in order to keep optical power measured in downstream of the AWG in constant;

FIG. 7A shows temperature dependence of optical power measured in upstream of the AWG, and FIG. 7B shows an example of temperature dependent weighting factor;

FIG. 8 shows temperature dependence of optical power of a wavelength multiplexed signal measured in downstream of the AWG;

FIG. 9 compares I-L characteristic of an LD measured in beginning of life (BOF) with that caused by long-term degradations;

FIG. 10 shows temperature dependence of optical power of an optical signal measured in upstream of the AWG;

FIG. 11 shows temperature dependence of a ratio of the modulation current against the bias current, by which an LD shows a preset average output power and a preset extinction ratio;

FIG. 12 shows a flowchart of procedures to keep average power and an extinction ratio of an optical signal measured in downstream of the AWG in constant; and

FIG. 13 compares an extinction ratio compensated for the long-term degradation only by the bias current with that by both the bias current and the modulation current.

### DESCRIPTION OF EMBODIMENTS

Next, some embodiments according to the present application will be described as referring to accompanying drawings. In the description of the drawings, numerals or symbols same with or similar to each other will refer to elements same with or similar to each other without duplicating explanations. The present invention may be not restricted to those embodiments, and could include all modifications from those recited in claims and equivalents thereto.

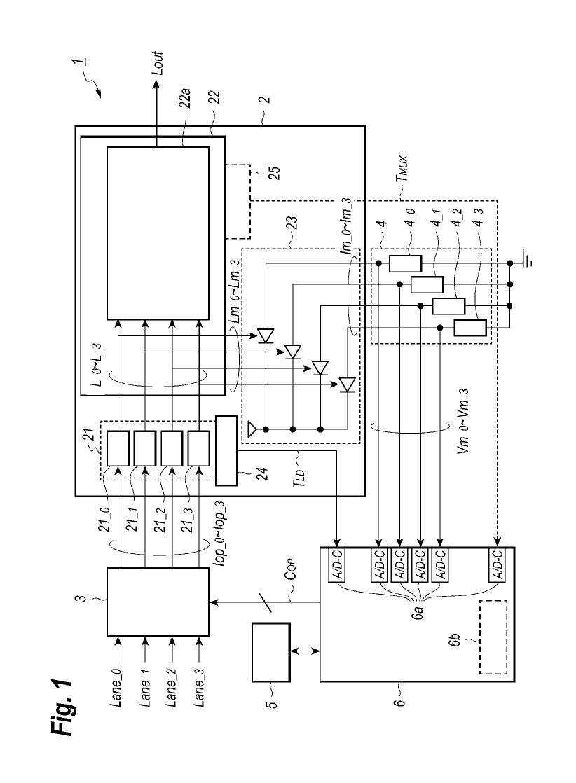

FIG. 1 schematically illustrates a functional block diagram of an optical transmitter according to an embodiment of the present application. The optical transmitter 1 converts electrical signals carried on respective channels Lane_n, where n is an integer from 0 to 3 in the present embodiment (n=0 to 3). In the description below, index “_n” subsequent to parameters means the same condition; that is, n takes from 0 to an integer corresponding to the number of the multiplicity minus one. The optical transmitter 1 converts thus received electrical signals into optical sub-signals L_n that have respective wavelengths different from each other, and outputs a wavelength multiplexed optical signal Lout that multiplexes the optical sub-signals L_n. Each of channels Lane_n has a transmission speed of, for instance 10 Gbps. The optical transmitter 1, which conforms to one of the MSAs called QSFP+, may perform the full duplex communication multiplexing four sub-signals. The optical transmitter 1 may be operable in a temperature range of −5 to 70° C., and comprise a wavelength division multiplexing transmitter optical sub-assembly (WDM-TOSA) 2, a driver 3, a current sensor 4, a memory, and a controller 6.

The WDM-TOSA 2 includes an optical source 21, an optical multiplexer 22, a power monitor 23, and a temperature sensor 24. The optical source 21 includes LDs 21_n each generating the sub-signals L_n having wavelengths λ_n different from each other. The LDs 21_n in the emission wavelengths λ_n thereof depend on the temperature T_{LD} thereof. Specifically, the emission wavelength of an LD shifts by about 0.1 nm as the temperature thereof changes by 1° C., or the temperature dependence of the emission wavelength of an LD is about 0.1 nm/° C. Accordingly, assuming the operable temperature range for the optical transmitter 1 is −5 to 70° C., the emission wavelength of the LDs 21_n varies at least by 7.5 nm.

The optical multiplexer 22 has wavelength dependent insertion loss for an optical signal transmitting therethrough. The optical multiplexer 22 multiplexes the sub-signals L_n emitted from the LDs 21_n, and outputs the wavelength multiplexed signal Lout. The optical multiplexer 22 also splits the sub-signals L_n to respective monitored signals Lm_n in upstream of the optical multiplexer 22. The optical multiplexer 22 may include an AWG, which is formed by a planar lightwave circuits (PLC). The optical sub-signals L_n attenuate as passing through the optical multiplexer 22 due to the insertion loss of the optical multiplexer 22.

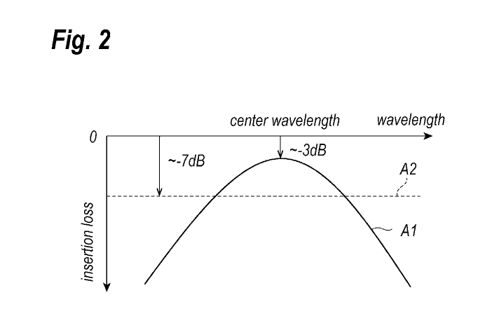

FIG. 2 schematically illustrates wavelength dependence of the insertion loss of an AWG. In FIG. 2, a solid line A1 corresponds to the insertion loss caused by an AWG, and a broken line A2 corresponds to that of a 3 dB coupler also having a function of the wavelength multiplexing. The insertion loss is defined by a ratio of the power of an optical signal transmitting the AWG against the power of the optical signal entering the AWG. Because the optical signal transmitting the AWG, namely, the optical output of the AWG, contains a plurality of sub-signals multiplexed to each other, the insertion loss of the AWG may be defined for respective sub-signals independently. In an example, setting the power of the sub-signal L_0 in upstream of the AWG to be Pin(λ_0) and the power in downstream of the AWG to be Pout(λ_0), the insertion loss may be defined by Pout/Pin, or Pout (λ_0) [dB]−Pin (λ_0) [dB].

As illustrated in FIG. 2, an AWG shows the insertion loss of −3 dB at the designed center wavelength but relatively larger insertion loss as the wavelength is apart from the designed center wavelength. On the other hand, a 3 dB coupler, which is another type of the optical multiplexer, has the greater insertion loss of about −7 dB but substantially no wavelength dependence. In order to output the wavelength multiplexed signal Lout with the preset target amplitude, respective sub-signals L_n are necessary to be increased to compensate the insertion loss due to the optical multiplexer 22, which may be carried out by increasing the driving currents supplied to the LDs 21_n. The increase of the driving current inevitably brings the increase of the power consumption. Accordingly, the sub-signals L_n in the wavelengths thereof are set in a range where the insertion loss by the optical multiplexer 22 becomes less than that of the 3 dB coupler, namely, in a range closer to the center wavelength.

Referring back to FIG. 1, the power monitor 23 converts the optical power of the monitored signals Lm_n split from the sub-signals L_n into respective photocurrents Im_n, and provides thus generated photocurrents Im_n to the current sensor 4. The power monitor 23 includes photodiodes (PDs) 23_n, cathodes of which are connected to a power supply, while, anodes are grounded through respective sensing resistors 4_n in the current sensor 4. The PDs 23_n generate respective photocurrents Im_n corresponding to the received monitored signal Lm_n. Because the sub-signals L_n are modulated by high frequencies, the monitored signals Lm_n are also modulated with high frequencies. However, the photocurrents Im_n contain frequency components restricted by the high-frequency performance of the PDs 23_n. The photocurrents Im_n in the frequency components thereof are restricted to several giga-hertz at most even when the sub-signals L_n have the transmission speed of 25 Gbps or higher.

The temperature sensor 24 senses the temperature T_{LD} of the optical source 21. Although the embodiment shown in FIG. 1 provides one temperature sensor 24 for sensing a temperature collectively for respective LDs 21_n, the optical transmitter 1 may provide two or more temperature sensors for sensing temperatures of respective LDs 21_n independently. The temperature sensor 24 provides the sensed temperature to the controller 6. The temperature sensor 6 may be a thermistor having large temperature dependence of resistance thereof. For instance, a resistive divider comprising of a resistor and a thermistor connected in series to the resistor may output a voltage signal corresponding to a sensed temperature.

The WDM-TOSA 2 may further provide another temperature sensor 25 to sense a temperature T_{MAX} of the optical multiplexer 22. The temperature sensor 25 provides the sensed temperature of the optical multiplexer 22 to the controller 6. This temperature sensor 25, similar to that of the aforementioned temperature sensor 24, may be a thermistor connected in series to a resistor to convert the sensed temperature into a voltage signal to be provided to the controller 6.

The driver 3, which may be formed as an integrated circuit (IC), provides driving currents Iop_n to respective LDs 21_n. The driving current Iop_n includes bias currents Ibias_n and modulation currents Imod_n. The driver 3 sets the bias currents Ibias_n and the modulation currents Imod_n based on the command Cop provided from the controller 6. The driver 3, depending on the signals carried on the respective channels Lane_n, turns on/off the modulation currents Imod_n, and provides thus turned on/off modulation currents Imod_n superposed with the bias currents Ibias_n to the LDs 21_n. The bias currents Ibias_n and the modulation currents Imod_n may be specific to respective channels Lane_n and may be different from each other.

The current sensor 4 converts the photocurrents Im_n output from the power monitor 23 into voltage signals Vm_n. The current sensor 4 may include resistors 4_n whose one ends are connected to the anodes of the PDs 23_n and other ends thereof are grounded. Providing the photocurrents Im_n in the resistors 4_n, voltage drops occur in the resistors 4n to generate the voltage signals Vm_n. The current sensor 4 may further include capacitors each connected in parallel to the resistors 4_n to eliminate high frequency components from the voltage signals Vm_n. In such a case, the voltage signals Vm_n become averages of the respective photocurrents Im_n.

The memory 5 may store a look-up-table that correlates the bias currents Ibias_n and the modulation current Imod_n to the temperature T_{LD} for respective LDs 21_n to maintain the optical power of the wavelength multiplexed signal Lout in the target power. The memory 5 may be a random access memory (RAM), a read only memory (ROM), a flash ROM, and so on. Details of the look-up-table will be described later.

The controller 6, which may be a micro-processor, determines the next bias currents Ibias_n and the next modulation currents Imod_n to be supplied to the LDs 21_n, based on the look-up-table stored in the memory 5 and the sensed temperature T_{LD}, to maintain the optical power of the wavelength multiplexed signal Lout in the target power or to make the optical power of the sub-signals L_n measured in downstream of the optical multiplexer 22 to be respective target power. The controller 6 sends the command Cop to the driver 3 to supply the next bias currents Ibias_n and the next modulation currents Imod_n to the optical source 21. The command Cop may be sent on serial communication lines of I2C (Inter-Integrated circuit) and/or SPI (Serial peripheral Interface), or lines specifically provided in the optical transmitter 1.

The controller 6 may provide an analog-to-digital converter (A/D-C) 6a. The temperature T_{LD} of the optical source 21 sensed by the temperature sensor 24, that Tₘᵤₓ of the optical multiplexer 22 sensed by the other temperature sensor 25, the voltage signals Vm_n output from the current sensor 4, and so on are analog signals. The controller 6 may include several A/D-Cs to convert those analog signals into respective digital data. The controller 6 may further provide a temperature sensor 6b to sense a temperature T_{C} of the controller 6. The temperature T_{C} sensed by the temperature sensor 6b is also converted into a digital data by an A/D-C 6a. The driver 3, the current sensor 4, the memory 5, and the controller 6 may be commonly mounted on a printed circuit board (PCB).

Next, an operation of the optical transmitter 1 will be described. The optical transceiver 1 may begin the operation thereof triggered by supplying the power thereto, negating the operational mode LPmode in which the power consumption of the optical transmitter 1 is saved, and/or negating the mode TxDisable in which the output optical signal is ceased. In the power saving mode, the optical transmitter 1 suspends portions of circuits to save the power consumption thereof below, for instance, 1.5 W. The status signal LPmode distinguishes the status of the power saving state from the normal state. Asserting the status signal LPmode, the optical transmitter 1 enters the power saving mode where the controller 6 suspends the operation of the driver 3 to cease the LDs 21_n. Negating the status signal LPmode, the driver 3 and the optical source 21 resume the operations thereof.

The resumption of the optical transmitter 1 from the power saving mode LPmode will be described. Providing the electrical signals in the respective channels Lane_n, the driver 3 turns on/off the modulation currents Imod_{—} n synchronizing with the electrical signals and determines the bias currents Ibias_n. The driver 3 supplies thus determined modulation currents Imod_n and the bias currents Ibias_n to the LDs 21_n. The LDs 21_n, being supplied with the driving currents Iop_n, generate the sub-signals L_n, and the optical multiplexer 22 multiplexes the sub-signals L_n into the wavelength multiplexed signal Lout to be output from the optical transmitter 1. Concurrently with the multiplexing of the sub-signals L_n, portions of the sub-signals L_n are split therefrom to the monitored signals Lm_n and sensed by the PDs 23_n that generate the photocurrents Im_n to be converted into voltage signals Vm_n by the resistors 4_n in the current sensor 4.

Correction of Insertion Loss

Next, procedures to correct or compensate the insertion loss of the optical multiplexer 22 will be described as referring to FIGS. 2 to 7. Although the description below concentrates on the one channel Lane_0, the explanations may be similarly applicable to the other channels, Lane 1 to Lane 3.

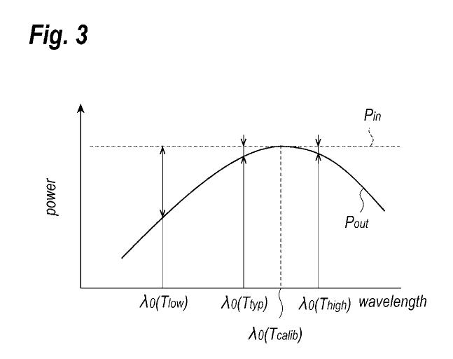

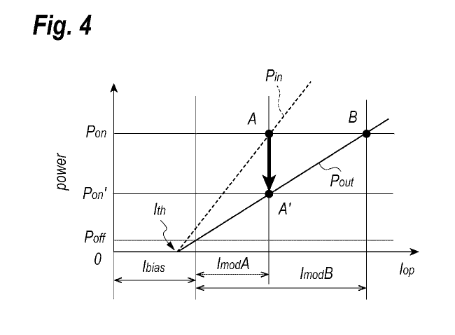

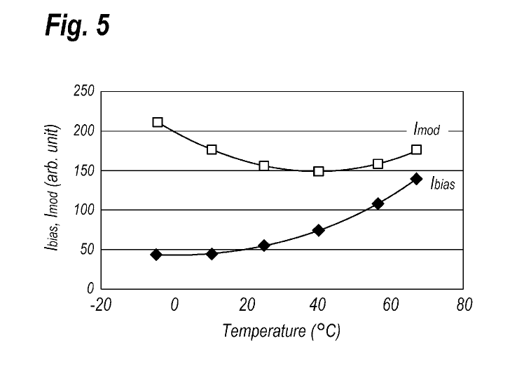

FIG. 3 shows the optical power of the sub-signal L_0, whose wavelength is λ_0 and involved in the wavelength multiplexed signal Lout, and that of the monitored signal Lm_0 split from the sub-signal L_0 in upstream of the optical multiplexer 22. In the description below, the sub-signals L_n in upstream of the optical multiplexer 22 is called as the raw sub-signals L_n, while, the sub-signals L_n in downstream of the optical multiplexer 22 is called as the transmitting sub-signals L_n. FIG. 4 schematically illustrates a current to power characteristic, which is often called as the I-L characteristic, of the raw sub-signal L_0 and that of the transmitting sub-signal L_n at the temperature T_{LD}. FIG. 5 shows the bias current Ibias_0 and the modulation current Imod_0 to keep the amplitude of the transmitting sub-signal L_0 in constant independent of the temperature.

In FIG. 3, the behavior Pout is the wavelength dependence of the optical power of the transmitting sub-signal L_0, and the behavior Pin is the wavelength dependence of the monitored sub-signal Lm_0, which is substantially equal to the wavelength dependence of the raw sub-signal L_0. That is, the behavior Pin corresponds to the input of the optical multiplexer 22 and the behavior Pout corresponds to the output thereof.

As described, the LD 21_0 shifts the emission wavelength λ_0 thereof as the temperature varies. Because the AWG 22a has the wavelength dependent insertion loss as shown in FIG. 2, the optical power of the transmitting sub-signal L_0 decreases when the emission wavelength λ_0 of the sub-signal L_0 shifts from the designed center wavelength. When the temperature T_{LD} of the LD 21_0 rises to a higher temperature Thigh from the center temperature Tcalib, at which the emission wavelength of the LD 21_0 matches with the center wavelength λ₀(Tcalib) of the AWG 22a, the emission wavelength becomes longer λ₀(Thigh). On the other hand, when the temperature T_{LD} falls to an ordinary temperature Ttyp, the emission wavelength λ_0 becomes shorter λ₀(Ttyp), and becomes further shorter λ₀(Tlow) when the temperature becomes in a lower temperature Tlow. Accordingly, the power or the amplitude of the transmitting sub-signal L_0 becomes a maximum when the temperature T_{LD} is the calibrating temperature Tcalib, and decreases as the temperature T_{LD} deviates from the calibrating temperature Tcalib because of the increase of the insertion loss of the AWG 22a.

That is, the optical power of the monitored signal Lm_0 is kept substantially constant in spite of the shift of the temperature T_{LD}, the optical power of the transmitting signal L_0 varies or decreases as the temperature T_{LD} shifts from the calibrating temperature Tcalib. Accordingly, even when the APC regularly controls the driving current Iop_0 for the LD 21_0 based on the monitored signal Lm_0 to keep the power of the monitored signal Lm_0 in constant, the power of the transmitting signal L_0 may be not maintained in the target optical power when the temperature T_{LD} varies from the calibrating temperature.

The optical transmitter 1 of the present embodiment adjusts the bias current Ibias_0 and the modulation current imod_0 depending on the temperature T_{LD} such that the power of the transmitting signal L_0 may be kept substantially in constant. For instance, when the modulation current Imod_0 to get the target power Pon for the raw sub-signal L_0 is a value ImodA, which is shown by the behavior Pin and at the point A; the transmitting sub-signal L_0, which corresponds to the behavior Pout, only shows the power Pon′, namely point A′, for such a modulation current ImodA because of the insertion loss of the AWG 22a. In order to compensate the insertion loss of the AWG 22a, the modulation current provided to the LD 21_0 is necessary to be increased to the point B on the behavior Pout, that is, the modulation current ImodB is necessary to be provided to the LD 21_0. Under such a condition, the power of the transmitting sub-signal L_0 may be kept constant in the target one and the multiplexed optical signal Lout may also maintain the optical power thereof in the designed power.

In FIG. 4, the threshold current Ith for the laser emission is independent of the insertion loss of the AWG 22a; accordingly, the compensation for the bias current Ibias may be negligible when temperature dependence of a difference between the bias current Ibias and the threshold current Ith is small enough, where this condition is usually satisfied in a practical LD. However, the present optical transmitter 1 also adjusts the bias current Ibias as the temperature T_{LD} varies by the reason described below.

As described, the insertion loss of the AWG 22a has the wavelength dependence, and the emission wavelength of the sub-signal L_0 has the temperature dependence. Accordingly, the modulation current Imod_0 to compensate the insertion loss of the AWG 22a shows the temperature dependence. Moreover, the I-L characteristic of the LD 0 shows the temperature dependence, where the modulation current Imod_0 and the bias current Ibias_0 to get the designed power and the designed extinction ratio generally increase as the temperature T_{LD} increases as illustrated in FIG. 5. Accordingly, the look-up-table in the memory 5 may store the relation of the two currents of the bias current Ibias and the modulation current Imod against the temperature T_{LD}.

Table below shows an example of the look-up-table to maintain the optical power of the transmitting sub-signal L_0 in constant, where the currents are denoted as digital values to be set in digital-to-analog converters.

TABLE 1
Example of Data in Look-up-Table

| temperature | bias current | modulation current |
|---|---|---|
| T_{LD} | (Ibias) | (Imod) |
| −10 | 47 | 227 |
| 0 | 43 | 197 |
| 10 | 44 | 173 |
| 20 | 49 | 156 |
| 30 | 59 | 147 |
| 40 | 74 | 144 |
| 50 | 93 | 148 |
| 60 | 116 | 160 |
| 70 | 145 | 178 |
| 80 | 178 | 203 |

The controller 6, referring to the look-up-table above, fetches the bias current Ibias and the modulation current Imod corresponding to the temperature T_{LD} provided from the temperature sensor 24, and supplies the bias current Ibias and the modulation current Imod thus obtained to the driver 3.

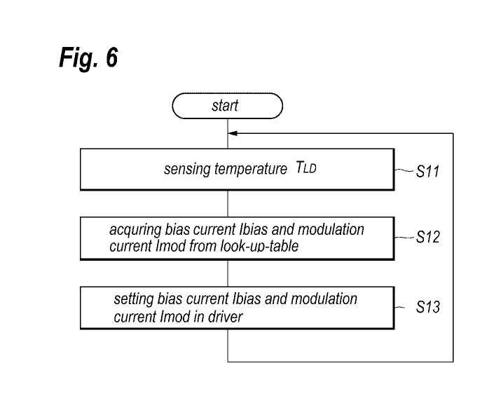

Next, procedures of controlling the driving current Iop_n to compensate the insertion loss of the optical multiplexer 22 will be described as referring to FIG. 6, which is a flow chart of the procedures. The procedures begin with the negation of the status signal LPmode that sets the optical transmitter 1 in the power saving mode and/or the negation of the command TxDisable that suspends the optical output.

First, the temperature sensor 24 senses the temperature T_{LD} of the optical source 21, and the sensed temperature is sent to the controller 6 at step S11. Next, the controller 6 fetches from the look-up-table the bias current Ibias and the modulation current Imod corresponding to the temperature T_{LD} as step S12, and sets thus fetched bias current Ibias and the modulation current Imod in the driver 3 through the command ling Cop at step S13. The procedures from S11 to S13 iterate until the status signal LPmode is asserted and/or the command TxDisable is asserted.

Thus, the optical transmitter 1 may compensate the insertion loss of the optical multiplexer 22 without sensing the power of the wavelength multiplexed signal Lout, which is output from the optical multiplexer 22 and just the subject signal to be controlled in the optical power thereof, but using the temperature T_{LD} of the optical source 21.

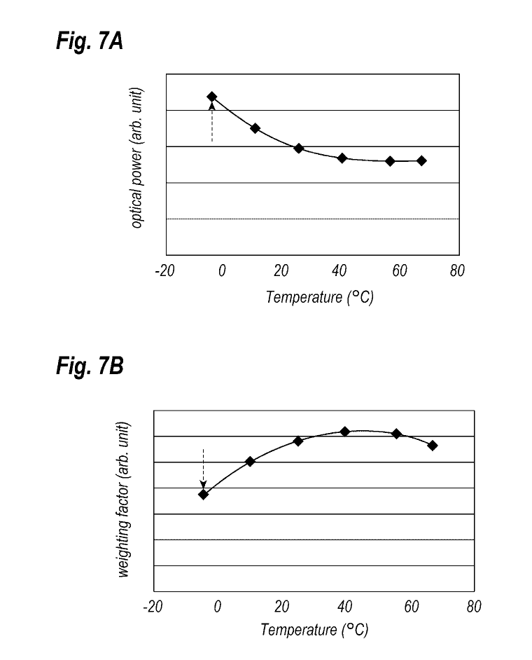

The optical transmitter 1 of the present embodiment sets a larger modulation current Imod as the temperature T_{LD} becomes lower; accordingly, the amplitude of the raw optical signals L_n becomes larger and the monitored signals Vm_n becomes larger as the temperature T_{LD} falls, which is indicated in FIG. 7A. Preparing a reverse of the behavior shown in FIG. 7A, which typically becomes those shown in FIG. 7B, the optical power of the wavelength multiplexed signal Lout currently output from the optical transmitter 1 may be easily estimated by multiplying the optical power of the monitored sub-signals Lm_n with the behavior shown in FIG. 7B.

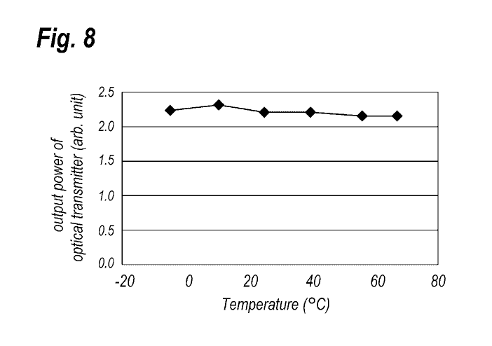

Next, some advantages of the present optical transmitter 1 will be described. FIG. 8 shows the temperature dependence of the optical power of the wavelength multiplexed signal Lout output from the optical transmitter 1. The present optical transmitter 1, as shown in FIG. 8, may show the even temperature dependence of the output power thereof, which may be obtained by maintaining the power of the transmitting sub-signals L_n concurrently in constant in respective preset power by the procedures described above.

The optical transmitter 1 may have the look-up-table in the memory 5, where the look-up-table correlates the modulation current Imod and the bias current Ibias collectively to the temperature T_{LD} of the respective LDs 21_n. Fetching the specific conditions of the driving currents corresponding to the sensed temperature T_{LD} from the look-up-table and setting thus fetched conditions in the driver 3 through the command ling Cop, the driver 3 may supply the bias currents Ibias_n and the modulation currents Imod_n to respective LDs 21n. Thus, even when the wavelengths of the sub-signals L_n shift from the designed wavelengths due to the temperature change, the output power of the wavelength multiplexed signal Lout may be kept constant in the designed power. Accordingly, even when the optical transmitter 1 implements with an AWG as a wavelength multiplexing device, where an AWG inherently shows the wavelength dependent insertion loss of an optical signal transmitting therethrough, the APC may be stably and securely carried out. Moreover, because an AWG inherently shows a smaller insertion loss compared with a 3 dB coupler as far as the wavelength of the optical signal transmitting therethrough is around the center wavelength, the total power consumption of the optical transmitter may be saved.

Also, the look-up-table may keep the conditions of the driving current Iop_n independently for respective LDs 21_n. Accordingly, simple procedures to fetch the current conditions from the look-up-table and to set those current conditions to respective LDs 21_n independently may keep the output power of the optical transmitter 1 in constant in the present power.

Compensation for Long-Term Degradation of LD

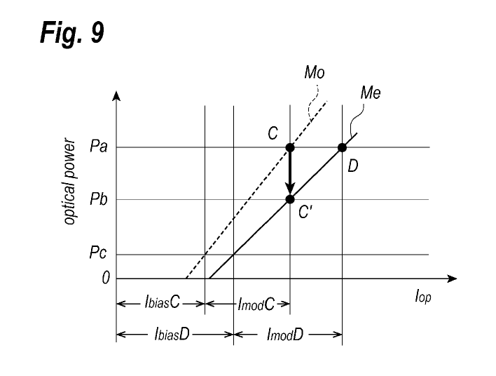

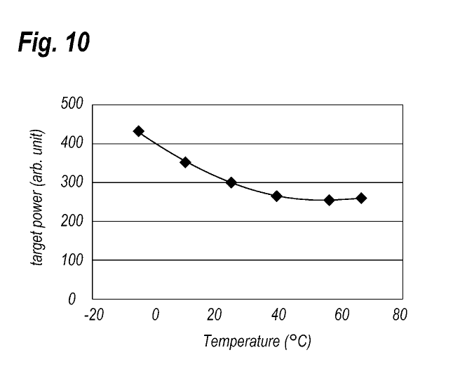

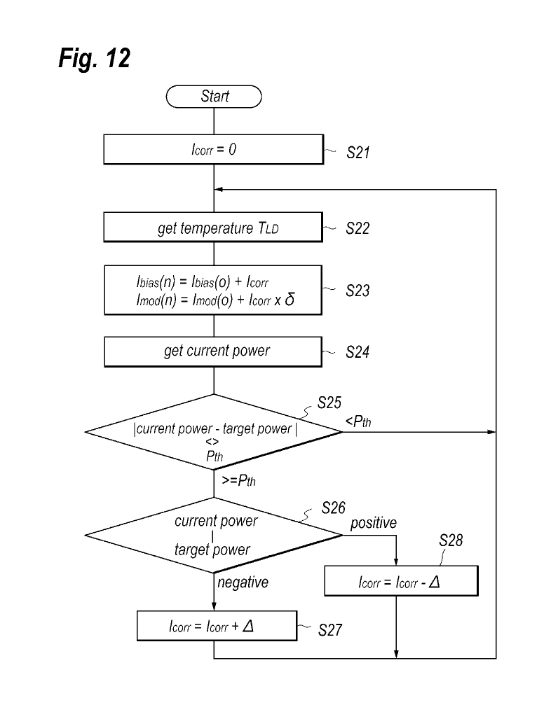

Next, the compensation of the long-term degradation of LDs 21_n will be described as referring to FIGS. 9 to 12. FIG. 9 compares, under an ordinary temperature Ttype, the I-L characteristic Mo at the original, or the begging of the life (BOF) of the LDs 21_n with that Me at the end of the life (EOF) or after being suffered with the long-term degradation. FIGS. 10 to 13 show the temperature dependence of the output power of the LDs 21_n, the temperature dependence of a ratio of the modulation current Imod_n against the bias current Ibias_n by which the target average power and the target extinction ratio of the optical output of the LDs 21_n are kept, and FIG. 12 is a flow chart to operate the LDs 21n taking the long-term degradation thereof into account, respectively.

As shown in FIG. 9, setting the bias currents Ibias_n and the modulation currents Imod_n at the beginning of the life of the LDs 21_n to be IbiasC and ImodC, respectively; the output power of the LDs 21_n becomes Pa. The long-term degradation of the LDs 21_n decreases the conversion efficiency from the current to the optical output, which corresponds to the slope of the I-L characteristic, and increases the threshold current Ith. Accordingly, the I-L characteristic of the LDs 21_n moves to the behavior Me after being suffered with the long-term degradation, and the output power obtained from the LDs 21_n by supplying the bias current IbiasC and the modulation current ImodC is reduced to the power Pb given by the point C′ on the I-L characteristic Me. In order to compensate the reduction of the optical power after being suffered with the long-term degradation; the bias current and the modulation current are necessary to be increased to IbiasD and ImodD, respectively, at which the optical power of the LDs 21_n recover the original power Pa given by the point D on the I-L characteristic Me. Thus, the optical power of the LDs 21_n may be maintained in the original power Pa.

Almost all applications implementing with an LD request that (1) a ratio of the optical power Pa corresponding to the status “1” against the optical power Pc corresponding to the status “0”, which is often called as the extinction ratio Pa/Pc, is kept greater than a preset ratio, and (2) average power of the status “1” and the status “0”, that is (Pa+Pc)/2, is also kept greater than a preset power. As illustrated in FIG. 9, the former power Pa is obtained when both bias current Ibias and the modulation current Imod are supplied to the LDs 21_n, but the latter power Pc is given when only the bias current Ibias is supplied. Accordingly, the optical transmitter 1 of the present embodiment sets the bias currents Ibias_n and the modulation currents Imod_n taking the ratios δ_n thereof into account. That is, the present optical transmitter 1 sets the modulation currents Imod_n based on the bias currents Ibias_n multiplied with the ratio δ_n.

In order to compensate for the long-term degradation of the LDs 21_n, the target power M_n for the raw sub-signals L_n, and the ratio δ_n of the currents are necessary. As shown in FIG. 7A, the output power of the raw sub-signals increases as the temperature T_{LD} falls because of the compensation for the increase of the insertion loss due to the optical multiplexer 22 at lower temperatures. Accordingly, during the production of the optical transmitter 1 in advance to the shipping thereof, the bias currents Ibias_n and the modulation currents Imod_n are measured such that the LDs 21_n show the preset average power and the preset extinction ratios at various temperatures, and the look-up-table may store the average power of the raw sub-signals L_N as the target power, the bias currents and the modulation currents correlating to the temperatures for respective LDs 21_n. As shown in FIG. 10, the target power of the raw sub-signals L_n become greater as the temperature T_{LD} falls.

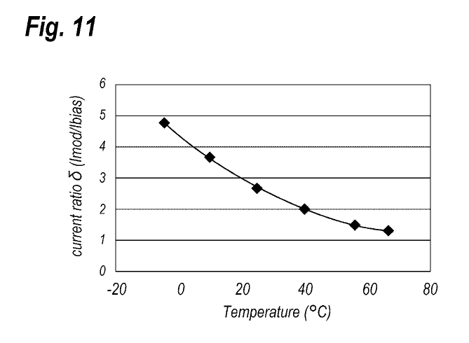

Also, the combinations of the bias currents and the modulation currents are different in respective temperatures. Accordingly, the ratio δ_n of the two currents also show the temperature dependence as shown in FIG. 11. Accordingly, the look-up-table preferably stores the ratios δ_n at respective temperatures by the calculation of the bias currents Ibias_n and the modulation currents Imod_n by which the preset target power and the preset target extinction ratio are obtained.

The look-up-table thus created correlates the bias current and the modulation current to be set in the LDs 21_n, the target output power, and the ratio δ to the temperatures. The controller 6, referring to the look-up-table in the memory 5, the sensed temperature T_{LD}, and the monitored amplitude Vm_n of the raw sub-signals L_n, adjusts the bias currents Ibias_n and the modulation currents Imod_n next supplied to the LDs 21_n. In other words, the controller 6 controls the bias currents Ibias_n and the modulation currents Imod_n in the driving currents Iop_n next supplied to the LD 21_n such that the monitored power derived from the parameters Vm_n become closer to the target power Mt_n. Table below shows an example of the look-up-table for one of the LDs 21_n, where the bias current, the modulation current, and the target power are denoted in respective arbitrary units, and only the temperature dependence thereof becomes important.

TABLE 2
Example of Data in Look-up-Table

| | bias | modulation | target | current |
|---|---|---|---|---|
| temperature | current | current | power | ratio |
| T_{LD} | Ibias_n | Imod_n | Mt_n | δ_n |
| −10 | 47 | 227 | 467 | 5.25 |
| 0 | 43 | 197 | 406 | 4.40 |
| 10 | 44 | 173 | 355 | 3.60 |
| 20 | 49 | 156 | 314 | 2.95 |
| 30 | 59 | 147 | 284 | 2.40 |
| 40 | 74 | 144 | 263 | 1.95 |
| 50 | 93 | 148 | 253 | 1.60 |
| 60 | 116 | 160 | 253 | 1.35 |
| 70 | 145 | 178 | 263 | 1.25 |
| 80 | 178 | 203 | 284 | 1.20 |

Further specifically, the controller 6 first fetches the bias currents Ibias_n and the modulation currents Imod_n from the look-up-table corresponding to the temperature T_{LD}, calculates the corrected bias currents and the corrected modulation currents each next supplied to the LDs 21₂n, and finally sends the command Cop to the driver 3 so as to set the next bias currents and the next modulation currents each corrected from the stored currents fetched from the look-up-table. The correction of the two currents will be described below.

Procedures to operate the optical transmitter 1 including the compensation for the insertion loss of the optical multiplexer 22 and the long-term degradation of the LDs 21_n will be described as referring to FIG. 12. The operation described below is triggered by the negation of the status signal LPmode and/or that of the command TxDisable.

First, the controller 6 sets the current correction factor Icorr to be zero at step S21. Sensing the temperature T_{LD} at step S22, the controller 6 fetches from the look-up-table the bias current Ibias_n(o), the modulation current Imod_n(o), the target power Mt_n, and the current ratio δ_n corresponding to the current temperature T_{LD}. Subsequently, the controller 6 calculates the bias currents Ibias_n(n) and the modulation currents Imod_n(n) next set in the LDs 21_n by the equations of:

Ibias_n(n)=Ibias_n(o)+Icorr, and

Imod_n(n)=Imod_n(o)+Icorr*δ_n.

Because the first loop sets the current correction factor Icorr to be zero, the controller 6 sets the next bias current Ibias_n (n) and the next modulation current Imod_n (n) to be equal to those just fetched from the look-up-table. Because the second and subsequent loops adjust the current correction factor Icorr based on the difference between the current power of the raw sub-signals L_n and the respective target power Mt_n thereof, the bias currents Ibias_n(n) and the modulation current Imod_n (n) may be modified from those fetched from the look-up-table so as to set the current power of the raw sub-signals L_n equal to the target power thereof.

The driver 3, responding the command Cop sent from the controller 6, sets the next bias current Ibias_n (n) and the next modulation current Imod_n (n) to the LDs 21_n at step S24. The controller 6 gets the current optical power of the raw sub-signals L_n, where they are emitted from the LDs 21_n supplied with the next current conditions, and then compares thus obtained current optical power with the target power Mt_n red out from the look-up-table, at step S25.

When a difference between the current power and the target power Mt_n for respective LDs 21_n exceeds a preset threshold Pₜₕ, which is defined based on the loop gain of the APC loop comprised of the power monitor 23, the current sensor 4, the controller 6, the driver 3 and the optical source 21. When the difference is less than the preset threshold Pₜₕ, that is, the current power of the raw sub-signals L_n is substantially equal to the target power Mt_n, the procedures returns to step S22 to get the current temperature T_{LD}. On the other hand, when the difference exceeds the preset threshold Pₜₕ, the controller next compares the current power with the target power Mt_n.

That is, at step S26, when the current power is less than the target power Mt_n by at least the preset threshold, the controller adds an increment Δ to the current correction factor Icorr at step S27. On the other hand, when the current power is greater than the target power Mt_n, the controller 6 subtracts a decrement Δ from the current correction factor Icorr at step S28. Then, the controller iterates the procedures, S22 to S28, to get the current temperature T_{LD}, fetch parameters from the look-up-table, calculate the next bias current Ibias_n (n) and the next modulation current Imod_n(n) by the new current correction factor Icorr, set the next currents to respective LDs 21_n, and get new current power. In the procedures above described, the increment and/or the decrement Δ to adjust the current correction factor Icorr may correspond to a minimum variable range of a digital-to-analog converter (D/A-C), that is, when the control loop of FIG. 12 is done digitally, the increment and/or the decrement Δ may be one bit.

Also, when the first current power of the raw sub-signals L_n is greater than the target power in the first control loop where the bias currents Ibias_n(o) and the modulation current Imod_n(o) jest fetched from the look-up-table are set without performing any corrections thereto, the control loop decreases the current correction factor Icorr by the decrement Δ at step S28.

Thus, the optical transmitter 1 of the present embodiment may keep the output power of the wavelength multiplexed signal Lout without monitoring the wavelength multiplexed signal Lout but sensing the power of the raw sub-signals L_n before being processed by the optical multiplexer 22. The monitored optical power Lm_n of the raw sub-signals L_n and the current temperature T_{LD} of the optical source 21 may compensate the temperature dependence of the insertion loss of the optical multiplexer 22 and maintain the output power of the wavelength multiplexed signal Lout in constant. Also, not only the optical power of the raw sub-signals L_n but the extinction ratio in the temperature dependence thereof may be kept greater than a designed value.

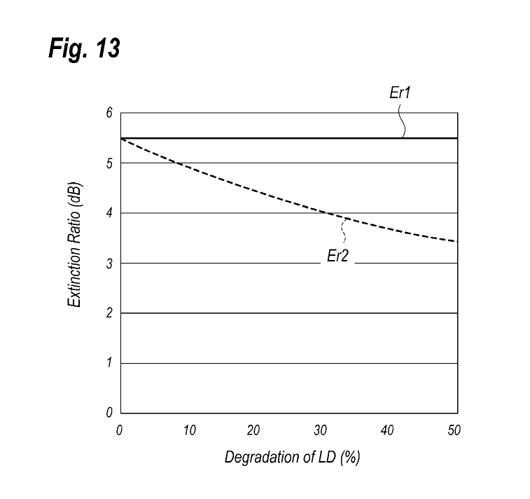

FIG. 13 shows the extinction ration of an LD against the degradation of the LD, where the degradation of the LD may be denoted as a ratio of a reduction of the optical power for the driving current Iop against the original power P(o), namely, (P(original)−P (long-term))/P(original); or a ratio of an increase of the driving current against the original driving current, namely, (Iop(long-term)−Iop(original))/Iop(original). Behavior ER1 shows a result when the long-term degradation of an LD is compensated by both the bias current Ibias and the modulation current Imod, while, the other behavior ER2 shows the result where the degradation is compensated only by the bias current Ibias. These behaviors assume that the slope efficiency n and the threshold current Ith are concurrently degraded by amounts substantially same with the other.

As shown in FIG. 13, the behavior ER1, which reflects the compensation only by the bias current Ibias, decreases the extinction ratio as the degradation of the LD increases. The increase only of the bias current accompanies with the increase of the optical power Poff corresponding to the “0” state, which results in a decrease of the extinction ratio (Pon+Poff)/Poff. On the other hand, the control of both the bias current Ibias and the modulation current Imod may maintain the extinction ratio in substantially constant with respect to the degradation of the LD. Not only the bias current Ibias but the modulation current Imod is increased as the degradation of the LD advances. Thus, the optical transmitter 1 of the embodiment may maintain the optical power of the wavelength multiplexed signal Lout output therefrom but the extinction ratios of respective transmitting sub-signals L_n contained in the wavelength multiplexed signal Lout.

Although the present invention has been fully described in conjunction with the preferred embodiment thereof with reference to the accompanying drawings, it is to be understood that various changes and modifications may be apparent to those skilled in the art. For instance, the number of the signal channels able to be processed by the optical transmitter 1 not limited to four (4). Five or more signal channels may be implemented with the optical transmitter 1. Also, the optical transmitter may process implement with only two or three signal channels.

The monitored signals Lm_n is split in the optical multiplexer 22 in the embodiment. However, the monitored signals Lm_n may be split at least in upstream of the optical multiplexer 22. The optical source 21 may not always install LDs 21_n within a signal package. Restive LDs 21_n may be enclosed in packages independent to each other. Also, respective packages for the LDs 21_n may implement with monitor PDs.

The description above concentrates on an arrangement where the current temperature T_{LD} is sensed by the temperature sensor 24 for the optical source 21. However, the controller 6 may refer to the temperature T_{MUX} of the optical multiplexer 22 and/or the temperature T_{C} of the controller 6 sensed by the temperature sensor 6b. Such changes and modifications are to be understood as included within the scope of the present invention as defined by the appended claims, unless they depart therefrom.

1. A method of controlling an optical transmitter implemented with an laser diode (LD) that generates a sub-signal with a temperature dependent wavelength, and an optical multiplexer that multiplexes the sub-signal, the optical multiplexer having wavelength dependent insertion loss for an optical signal transmitting therethrough, the method comprising steps of:
sensing an operating temperature of the LD;
deciding a condition of the LD at the operating temperature such that the sub-signal transmitting through the optical multiplexer has optical power substantially independent of the operating temperature; and
setting the condition in the LD.

2. The method of claim 1,
wherein the condition of the LD includes a bias current and a modulation current,
wherein the method further includes steps of, in advance to the step of sensing the operating temperature,
obtaining combinations of the bias current and the modulation current by which the optical power of the sub-signal transmitting through the optical multiplexer becomes a preset power as varying the operating temperature of the LD, and
creating a look-up-table that includes the bias currents and the modulation currents correlating to the temperatures, and
wherein the step of deciding the condition of the LD includes a step of fetching the combination of the bias current and the modulation current at the operating temperature from the look-up-table.

3. The method of claim 2,
wherein the step of obtaining the combinations includes a step of measuring optical power of the sub-signal in upstream of the optical multiplexer as varying the operating temperature, and the step of creating the look-up-table includes a step of storing the optical power correlating to the operating temperature in the look-up-table, and
wherein the method further includes a step of comparing current optical power of the sub-signal in upstream of the optical multiplexer with the optical power stored in the look-up-table.

4. The method of claim 3,
further including a step of:
decreasing the bias current and the modulation current when the current optical power of the sub-signal in upstream of the optical multiplexer is less than the optical power stored in the look-up-table, and increasing the bias current and the modulation current when the current optical power of the sub-signal in upstream of the optical multiplexer is greater than the optical power stored in the look-up-table.

5. The method of claim 4,
wherein the step of decreasing the bias current and the modulation current includes a step of decreasing the bias current and the modulation current from the currently supplied bias current and the currently supplied modulation current by an amount, and the step of increasing the bias current and the modulation current includes a step of increasing the bias current and the modulation current from the currently supplied bias current and the currently supplied modulation current by an amount.

6. The method of claim 4,
wherein the step of creating the look-up-table includes a step of storing ratios of the modulation currents to the bias currents correlating to the operating temperatures.

7. The method of claim 6,
wherein the step of increasing the bias current and the modulation current includes a step of increasing the bias current by a preset amount from the currently supplied bias current and increasing the modulation current by the preset amount multiplied with the ratio of the modulation current to the bias current stored in the look-up-table.

8. The method of claim 6,
wherein the step of decreasing the bias current and the modulation current includes a step of decreasing the bias current by a preset amount from the currently supplied bias current and decreasing the modulation current by the preset amount multiplied with the ratio of the modulation current to the bias current stored in the look-up-table.

9. The method of claim 4,
wherein the optical transmitter further includes another LD that generates another sub-signal with a wavelength different from the wavelength of the LD, the optical multiplexer multiplexing the sub-signal and the another sub-signal, and
wherein the step of decreasing the bias current and the modulation current, and the step of increasing the bias current and the modulation current are performed for the respective LDs independently.

10. An optical transmitter, comprising:
an optical source that includes at least two laser diodes (LDs) each generating sub-signals having wavelengths different from each other;
an optical multiplexer that multiplexes the sub-signals and generates a wavelength multiplexed signal, the optical multiplexer having a wavelength dependent insertion loss for an optical signal transmitting therethrough;
a driver that supplies driving currents to the at least two LDs independently;
a temperature sensor that senses a temperature of an inside of the optical transmitter;
a controller that maintains optical power of the sub signals transmitting through the optical multiplexer in a preset power independent of the temperature by setting the driving currents to the at least two LDs based on optical power of the sub-signals in upstream of the optical multiplexer.

11. The optical transmitter of claim 10,
wherein the driving currents each supplied to the respective LDs include bias currents and modulation currents,
wherein the optical transmitter further comprises a look-up-table that correlates the bias currents and the modulation current to the temperature of the inside of the optical transmitter, and
wherein the controller sets the bias currents and the modulation currents each stored in the look-up-table to the respective LDs through the driver.

12. The optical transmitter of claim 10,
wherein the optical multiplexer is a type of an arrayed waveguide (AWG) having the wavelength dependent insertion loss that increases as the wavelength of the optical signal transmitted therethrough is apart from a center wavelength.

13. The optical transmitter of claim 12,
wherein the wavelengths of the sub-signals each generated by the at least two LDs dependent on the temperature.

14. The optical transmitter of claim 10,
wherein the temperature sensor senses a temperature of the optical source as the temperature of the inside of the optical transmitter.

15. The optical transmitter of claim 10,
wherein the temperature sensor senses a temperature of the optical multiplexer as the temperature of the inside of the optical transmitter.

16. The optical transmitter of claim 10,
wherein the temperature sensor is integrated within the controller and senses a temperature of the controller as the temperature of the inside of the optical transmitter.
